(19) United States
(12) Patent Application Publication
(10) Pub. No.: US 2026/0018989 A1
(43) Pub. Date: Jan. 15, 2026

(54) Optimized Snubber

(71) Applicant: Rompower Technology Holdings, LLC, Milford, DE (US)

(72) Inventor: Ionel Jitaru, Tucson, AZ (US)

(73) Assignee: Rompower Technology Holdings, LLC, Milford, DE (US)

(21) Appl. No.: 19/334,866

(22) Filed: Sep. 20, 2025

Related U.S. Application Data
(63) Continuation-in-part of application No. 19/221,463, filed on May 28, 2025.
Application No. 19/221,463 is a continuation-in-part of application No. 18/743,055, filed on Jun. 13, 2024.
Application No. 18/743,055 is a continuation-in-part of application No. 18/233,315, filed on Aug. 12, 2023, now abandoned.
Application No. 18/233,315 is a continuation of application No. 17/495,245, filed on Oct. 6, 2021, now Pat. No. 11,728,723.
Application No. 17/495,245 is a continuation-in-part of application No. 18/199,959, filed on May 21, 2023, now abandoned.
Application No. 18/199,959 is a continuation-in-part of application No. 17/495,170, filed on Oct. 6, 2021, now Pat. No. 11,671,027.
Application No. 17/495,170 is a continuation of application No. 16/751,747, filed on Jan. 24, 2020, now Pat. No. 11,165,360.
(63) Continuation-in-part of application No. 18/974,660, filed on Dec. 9, 2024.
Application No. 18/974,660 is a continuation-in-part of application No. 18/596,214, filed on Mar. 5, 2024, now abandoned.
Application No. 18/596,214 is a continuation of application No. 18/373,590, filed on Sep. 27, 2023, now Pat. No. 11,929,665.
Application No. 18/373,590 is a continuation-in-part of application No. 18/233,315, filed on Aug. 12, 2023, now abandoned.
Application No. 18/233,315 is a continuation-in-part of application No. 18/199,959, filed on May 21, 2023, now abandoned.
(60) Provisional application No. 63/377,229, filed on Sep. 27, 2022.
(60) Provisional application No. 63/508,252, filed on Jun. 14, 2023.
(60) Provisional application No. 63/508,254, filed on Jun. 14, 2023.
(60) Provisional application No. 63/578,130, filed on Aug. 22, 2023.
(60) Provisional application No. 63/608,019, filed on Dec. 8, 2023.
(60) Provisional application No. 63/652,578, filed on May 28, 2024.
(60) Provisional application No. 63/697,409, filed on Sep. 20, 2024.

(51) Int. Cl. H02M 1/08; H01F 38/42; H02M 1/00; H02M 1/34; H02M 1/42; H02M 3/155; H02M 3/335

(52) U.S. Cl. CPC H02M 1/083; H02M 1/4258; H02M 3/155; H02M 3/335; H02M 3/33553; H02M 3/33592; H01F 38/42; H02M 1/0058; H02M 1/342; Y02B 70/10

(57) ABSTRACT

A power converter includes a rectifying diode, an input circuit coupled to the rectifying diode, and an output circuit coupled to the rectifying diode. The converter further includes a subber circuit connected in parallel with the rectifying diode. The snubber circuit includes a controlled switching element which is a charge equalizer active switch configured to turn on at a critical time.

### CROSS-REFERENCE TO RELATED APPLICATIONS

This application claims the benefit of U.S. Provisional Application No. 63/697,408, filed Sep. 20, 2024. This application is a continuation-in-part of and claims the benefit of prior U.S. patent application Ser. No. 18/743,055, filed Jun. 13, 2024. This application is a continuation-in-part of and claims the benefit of prior U.S. patent application Ser. No. 18/974,660, filed Dec. 9, 2024. This application is a continuation-in-part of and claims the benefit of prior U.S. patent application Ser. No. 19/221,463, filed May 28, 2025. All of the above applications, as well as the applications to which they claim benefit, are hereby incorporated by reference in their entireties.

### FIELD

This specification relates generally to power conversation and more specifically to electronic devices employing snubber technology which can apply to many topologies used in power conversion.

### BACKGROUND

In most of the conventional topologies used in power converters abrupt voltage changes do occur which can result in transient ringing in the primary and secondary circuits of the transformer which in many applications separates the primary side to the secondary side.

The leakage inductance of said transformer and additional stray inductances and controlled inductances connected to the transformer, shortly named inductive elements connected to the transformer may interact resonantly with the jumction capacitances of the rectifiers connected to the transformer and in some application said inductive elements will be further energized by the reverse current through said rectifier due to the reverse recovery characteristics. In other applications wherein synchronous rectifiers are used the reverse recovery of the body diodes or reverse current through the synchronous rectifiers due to non-optimized drive circuit, may occur.

In addition to the said inductive elements and the parasitic capacitance across the rectifier means, there are the parasitic capacitances and stray inductances of the layout, all together determining the resonant frequency of said oscillations.

The spikes and ringing across said rectifiers means may exceed the maximum voltage rating or it may require higher voltage rating rectifier means which will negatively impact the efficiency of the power converter and may also increase the cost. The ringing across the rectifier means will increase the noise level in the control area of the power converter which can lead to distortion of the current sense signal and other negative effects.

To avoid these problems the ringing has to be damped. The damping shall be optimized because a heavy damping will increase the losses and reduce the efficiency of the power converter.

The snubber circuits apply to many topologies in power conversion. I will present the general concept of the snubber technology with applications in single ended forward topology. The embodiments described in this specification can apply to other topologies, and the disclosure or description of any particular topology or application should not be construed to limit the disclosure or description to that particular topology or application.

In FIG. 1 is presented the general concept of a snubber circuit placed across a switching element S_{W}, 30, connected across a resonant circuit, 60. The traditional snubber circuit is formed by a capacitor Cs, 50, in series with a resistor Rs, 40.

In FIG. 2 is depicted the circuit placed in the secondary of a single ended forward topology wherein there is a transformer Tr1, 70, a secondary winding Ls, 80, a forward rectifier means, Do1, 90, the inductive element Llk, 100 which can represent the leakage inductance of the transformer Tr1, 70, reflected into the secondary or it can represent an inductive element placed in the secondary with a given purpose such as creating a delay of the current flowing into the secondary winding, a parasitic capacitance Cp, 120, reflected across Do2 and a snubber circuit placed across the rectifier Do2, the snubber formed by a snubber capacitor Cs, 170, and a snubber resistor Rs, 180, and output inductor Lo, 140, an output capacitor Co, 150 and the load resistor R_{Load}, 160 and a switching node A, 110. Without the presence of the snubber circuit formed by Cs and Rs, the voltage in A is depicted in FIG. 3A.

The amplitude of the voltage in A, can exceed the voltage rating of the rectifiers. The snubber circuit, which is placed across the rectifiers, will dampen the ringing in switching node A, as depicted in FIG. 3B. The voltage in A, V(A), 210 has a smaller amplitude and the oscillation is dampened. In FIG. 3B is also depicted the voltage across the capacitor Cs, V(Cs), 200.

The ringing in the switching node A, 110, as depicted in FIG. 3A, is energized by the energy in the leakage inductance symbolically presented by Llk, 100. The damping effect of the ringing in the switching node A, is caused by the power dissipated in the snubber resistor Rs, 180. The energy stored in the leakage inductance and parasitic inductances and controlled inductances placed in the secondary is partially dissipated in the snubber resistor. To properly dump the ringing in the switching node A, 110, the value of the snubber resistor Rs 180, is preferably close to the characteristic impedance of the parasitic resonant circuit formed by Llk, Cp and Cs.

The snubber circuit depicted in FIG. 2 has a power loss occurring cycle by cycle to charge the snubber capacitor from zero to the maximum value of the overvoltage across Do2, 220 and further to discharge it to zero. The energy is proportional to the value of the capacitor, the switching frequency and the square value of the voltage swing on the capacitor. Because the power dissipated on the snubber resistor is proportionate with the square value of the voltage swing on the capacitor the losses on the snubber may become significant in higher voltage applications. In FIG. 3B are depicted some of the waveforms on the snubber circuit, such as the voltage in A, 110, and the voltage across the snubber capacitor, V(Cs), 200. To reduce the peak voltage across Do2, the snubber capacitor is preferably increased, which leads to a higher power dissipation on the snubber resistor Rs, 180.

### SUMMARY

A power converter includes a rectifying diode, an input circuit coupled to the rectifying diode, and an output circuit coupled to the rectifying diode. The converter further includes a snubber circuit connected in parallel with the rectifying diode. The snubber circuit includes a controlled switching element which is a charge equalizer active switch configured to turn on at a critical time.

The above provides the reader with a brief summary of an embodiment described below. Simplifications and omissions are made, and the summary is not intended to limit or define in any way the disclosure. Rather, this brief summary merely introduces the reader to some aspects of an embodiment in preparation for the detailed description that follows.

### BRIEF DESCRIPTION OF THE DRAWINGS

Referring to the drawings:

FIG. 1 it is an illustration in block diagram of a prior art snubber connected across a switching device.

FIG. 2 presents the secondary circuit of a power converter using a single ended forward topology and a conventional snubber.

FIG. 3A depicts the voltage across a rectifier in a switch mode power converter, without a snubber circuit across it.

FIG. 3B depicts the voltage across a rectifier using a conventional snubber circuit and the voltage across the snubber capacitor in a conventional snubber.

FIG. 4A depicts some of the waveforms of the circuit presented in FIG. 2.

FIG. 4B depicts some of the waveforms of the circuit from FIG. 2 when the rectifiers have reverse recovery current.

FIG. 5A presents a simplified secondary side circuit using output rectifiers and a conventional snubber placed across one of the rectifiers.

FIG. 5B presents the power dissipated on the snubber versus the leakage inductance wherein the rectifiers have reverse recovery current.

FIG. 6 presents the secondary circuit of a power converter using a single ended forward topology and a snubber circuit using a controlled switch Ss in series with the RC snubber.

FIG. 7 depicts some of the waveforms of the circuit presented in FIG. 6.

FIG. 8A presents an implementation of the circuit from FIG. 6.

FIG. 8B presents a second implementation of the circuit from FIG. 6.

FIG. 9A presents a snubber module using a controlled snubber switch.

FIG. 9B presents a snubber module wherein the control signal for the controlled snubber switch is provided by a control signal source.

FIG. 10 depicts an implementation of the snubber module from FIG. 9A.

FIG. 11 depicts the schematic of the secondary circuit of the power converter using a single ended forward topology and a current injection module.

FIG. 12 depicts some of the waveforms of the circuit presented in FIG. 10.

FIG. 13 depicts a prior art solution for a snubber circuit.

FIG. 14 depicts the schematic of an optimized snubber.

FIG. 15 depicts some of the waveforms of the circuit from FIG. 14.

FIG. 16 depicts some of the waveform of the current injection circuit presented in FIG. 11.

FIG. 17 presents the secondary of a power converter using a single ended forward topology using optimized snubbers across each rectifier.

FIG. 18 depicts some of the waveforms of the circuit presented in FIG. 17.

FIG. 19 depicts a power system using “n” numbers of optimized snubbers placed across “n” number of rectifier means.

FIG. 20 presents a method of energy extraction from the Cextr1 which collects the energy harvested by the optimized snubbers.

FIG. 21a presents the formula characterizing relation between Vc and Vo, n1 and n2.

FIG. 21b presents the formula for Vc as a function of Vo, n1, n2 and Vd.

### DETAILED DESCRIPTION

Reference now is made to the drawings, in which the same reference characters are used throughout the different figures to designate the same elements.

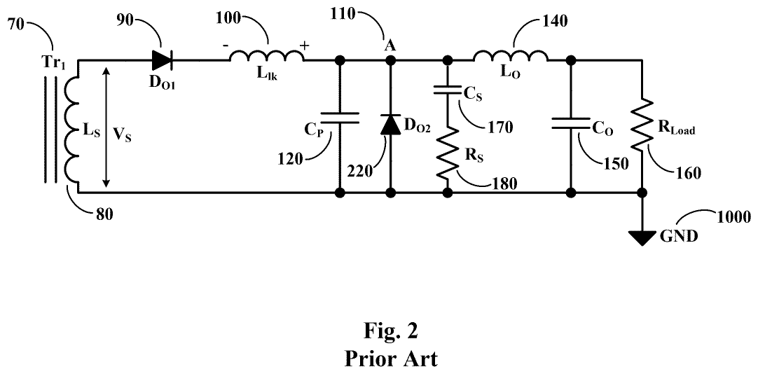

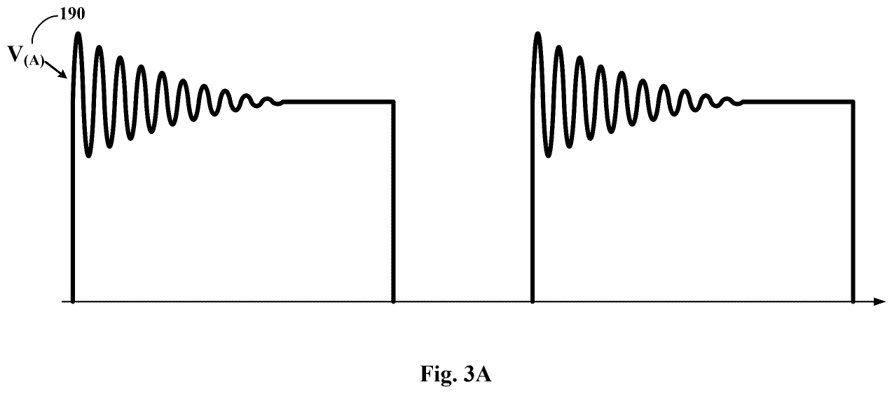

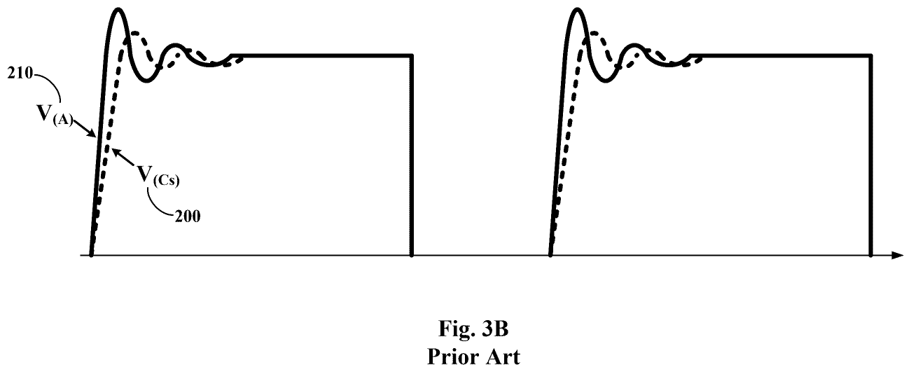

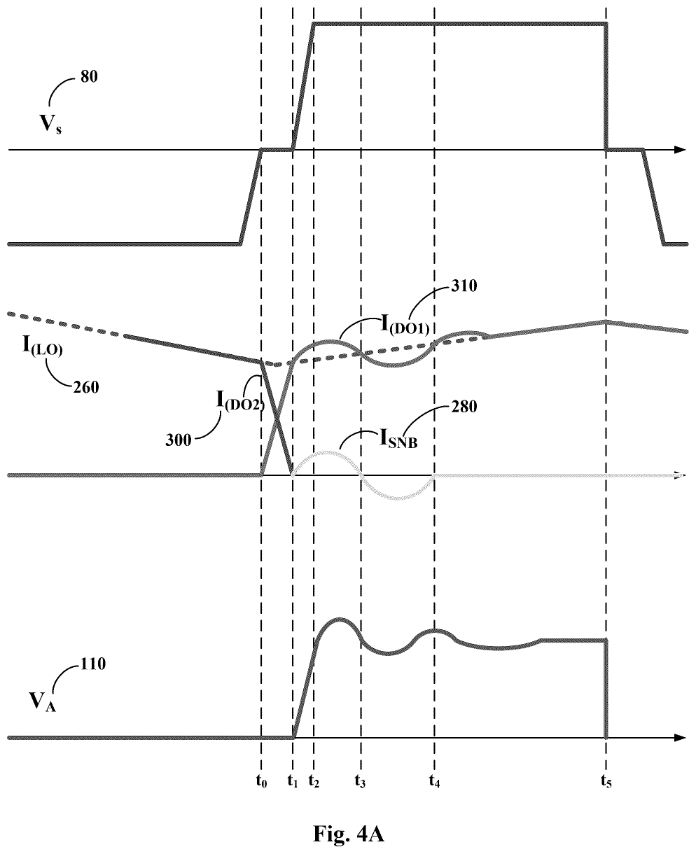

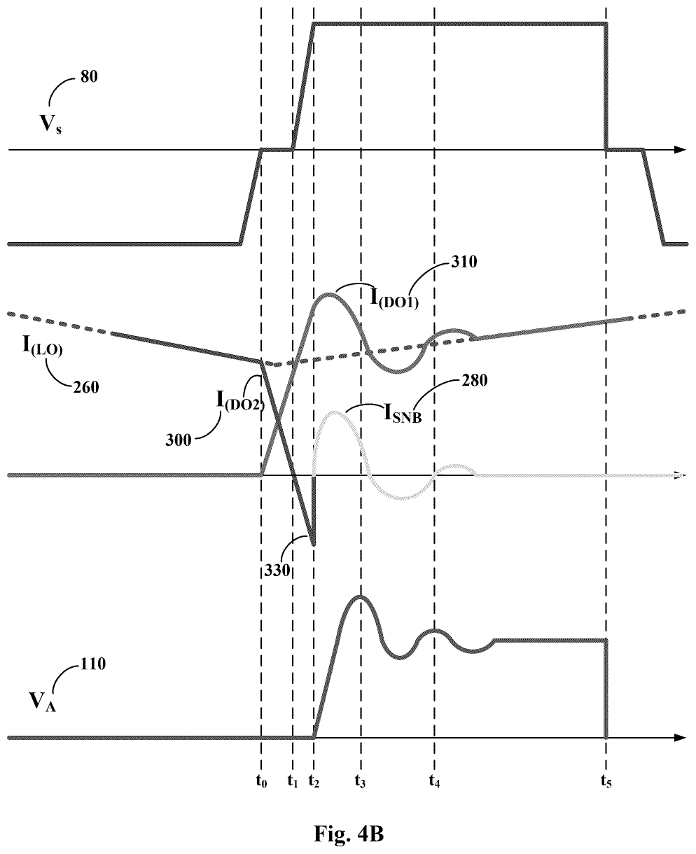

In FIG. 4A are depicted some of the waveforms associated with the snubber circuit applied to the single ended forward topology depicted in FIG. 2. The waveforms presented in FIG. 4A are: the voltage across the secondary winding Vs, 80, the currents through Lo, I(Lo), 260, I(Do2), 300, I(Do1) 310, and the current through the snubber circuit, I_{SNB}, and the voltage in the switching node A, V_{A}, 110. These waveforms apply in case when a Schottky rectifier is used wherein there is not reverse recovery current. In FIG. 4B are depicted some of the waveforms associated with the snubber circuit applied to the single ended forward topology depicted in FIG. 2, wherein the rectifier Do2 has a reverse recovery current, which can be also the reverse recovery of the body diode of a synchronous rectifier, or it can be a reverse current in a non-optimized driver for a synchronous rectifier. The waveforms presented in FIG. 4B are: the voltage across the secondary winding Vs, 80, the currents through Lo, I(Lo), 260, I(Do2), 300, I(Do1) 310, and the current through the snubber circuit, ISNB, and the voltage in the switching node A, V_{A}, 110. In FIG. 4B the reverse recovery current is depicted by the negative current flowing via Do2, 330. Due to the reverse recovery current the energy in the leakage inductance is larger and that is visible by the current injected in the snubber circuit, I_{SNB}. A portion of this energy is dissipated in the snubber circuit and also the peak voltage across the rectifier is increased.

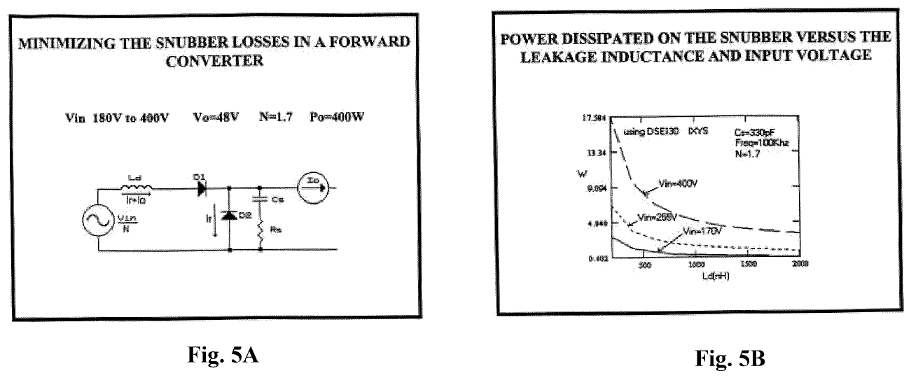

As previously mentioned, the power dissipated in the snubber resistor is proportional with the square value of the voltage across the snubber capacitor. The power dissipation in the snubber become a more significant portion of the power dissipation budget of a power converter for higher voltage application, especially when fast recovery diodes are used. In the HFPC' 1995, PAC4, seminar entitled “Techniques for Increasing Converter Efficiency and Power Densities” Ionel Jitaru is presenting the snubber losses in a single ended forward converter. In FIG. 5A, is depicted the losses in snubber in the secondary in a single ended forward converter wherein a snubber formed by Cs and Rs is placed across D2 in a 400W converter, 48V output using ultrafast rectifiers available in 1995. In FIG. 5B is presented the power dissipation in the snubber for different input voltage, from 180V to 400V, versus the leakage inductance in the transformer. As can be seen in FIG. 5B the power dissipation in the snubber reaches 4.3% of the output power at high line and very low leakage inductance. The increase of the leakage inductance reduces the reverse recovery current due to lower dI/dt.

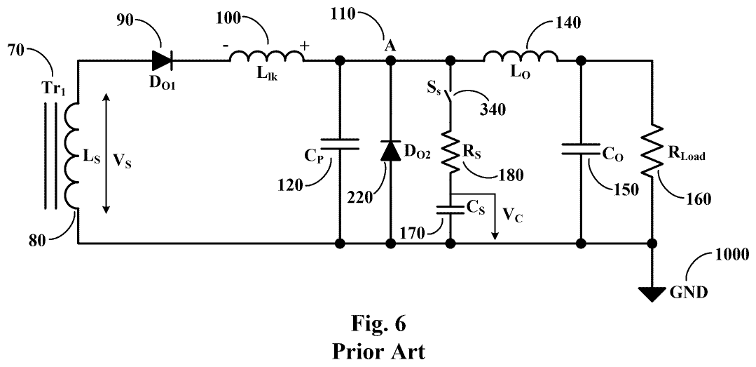

U.S. Pat. No. 7,408,793 presents a solution which eliminates one of the main drawbacks of the conventional RC snubber. FIG. 6 presents the secondary circuitry in a single ended forward topology similar to the one depicted in FIG. 2. A difference is the snubber circuit wherein the classical snubber formed by Cs and Rs is replaced by a snubber formed by a switch Ss in series with Rs and Cs.

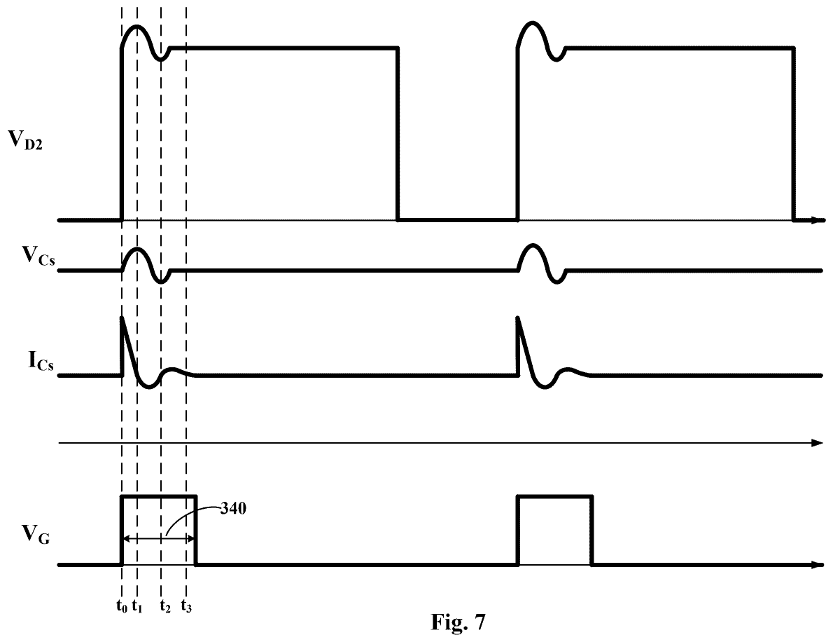

In FIG. 7 are depicted some of the waveforms associated with this snubber technology, such as the voltage across Do2, 220, the voltage across the snubber capacitor Cs, the current through the snubber capacitor, and the control signal V_{G} for the switch Ss. The switch Ss, 340, is turned on for a time interval 340. As a result, when Ss is off, the capacitor Cs does not discharge when the voltage in switching node A, 110, becomes zero. The capacitor Cs absorbs the energy from the leakage inductance Llk, 100, via the snubber resistor Rs.

In this type of snubber wherein the snubber capacitor is not fully discharged the current flowing through the snubber has to ensure the preservation of charge. As can be seen in FIG. 7, we identify several time periods. The first period is from t0 to t1. During this time the snubber capacitor is charged, time wherein a charge is injected in the snubber capacitor Cs, 170. The said charge must be removed between t1 to t3. During the ringing on the current through the clamp capacitor, I_{Cs}, visible also on the voltage across Cs, the charge injected and extracted from the Cs experience the same oscillations. In many applications there are damped oscillation, dumped in a dissipative way by the snubber resistor Rs, 180. By t3, the parasitic oscillation is fully dampened. In this type of snubber technology, the duration of the VG signal, 340, has to be larger than the time interval (t0-t3) to satisfy the preservation of charge. The switch. Ss, 340, which is part of a snubber circuit has to be controlled in such way that the charge injected in the snubber capacitor will be equal with the charge extracted from the snubber capacitor at the end of parasitic oscillation when the switch Ss, 340 is turned off. A switch which complies with this requirement is identified herein as a “charge equalizer switch”.

The solution previously described reduces significantly the power dissipation in the snubbers. In many applications the power dissipation in the snubber can be reduced hundreds of times in comparison with conventional snubbers.

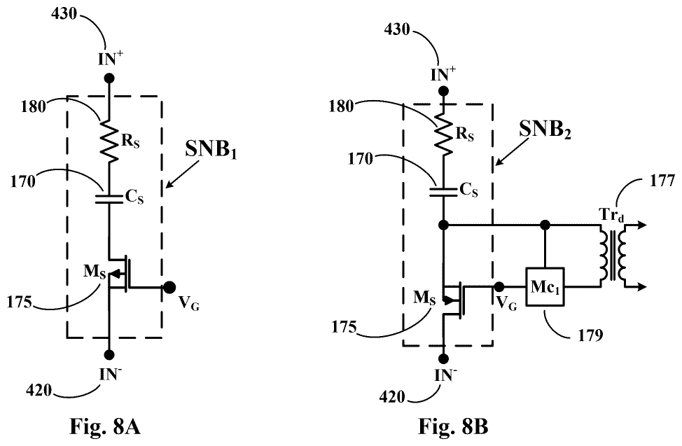

In FIG. 8A is presented the snubber circuit using this snubber technology by using a P channel Mosfet. The snubber circuit from FIG. 8A can be placed across the Do2, 220, from FIG. 6. Another implementation of this snubber is presented in FIG. 8B. In this implementation the switch is implemented by the use of a N channel Mosfet which is magnetically driven through the transformer Tr1.

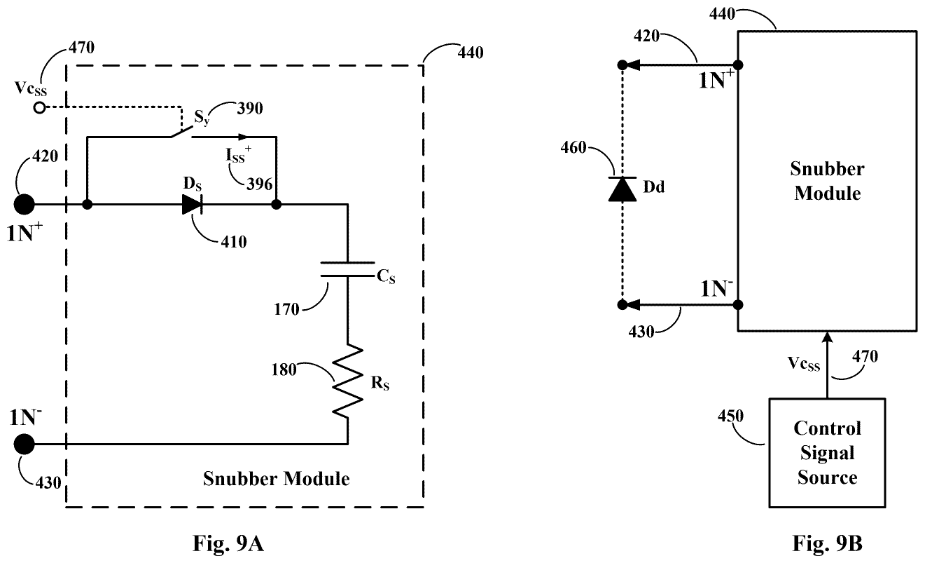

To make the snubber from FIG. 6 operate much more efficient is to implement the Ss, 340, as depicted in FIG. 9A.

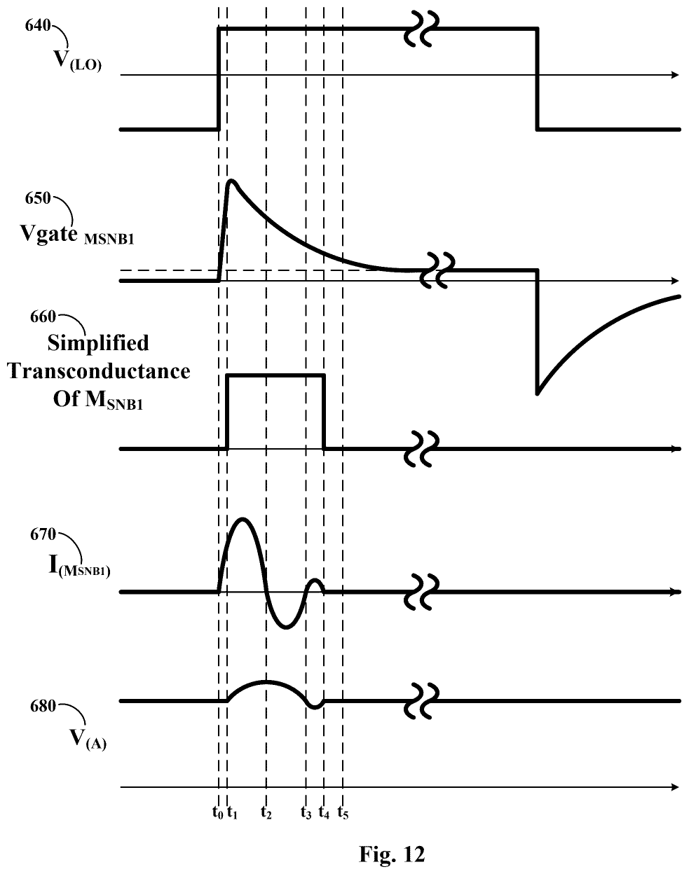

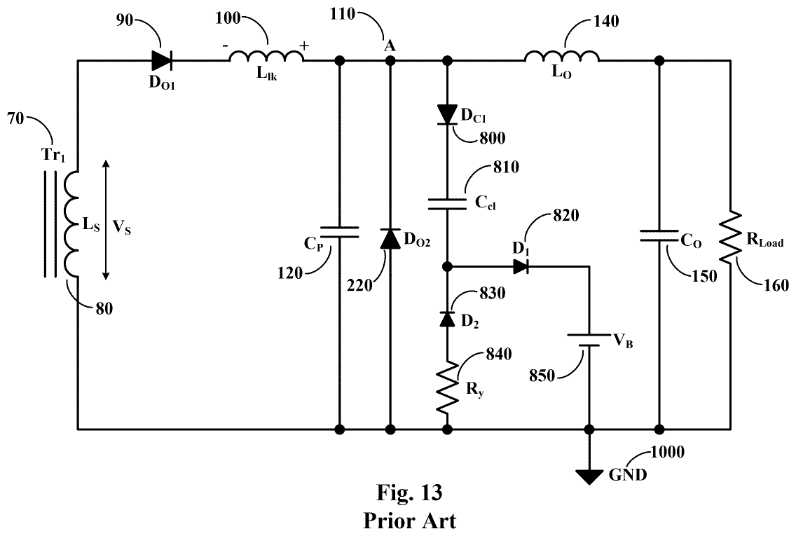

The timing for the turn on of Ss, 390 is critical. FIG. 12 of U.S. Pat. No. 7,408,793 presents the negative effect if the switch Ss (SW) is turned on slightly ahead of the optimum time and, in FIG. 13 of that same patent, are presented some of the waveforms of the snubber in the event wherein the snubber Ss (SW) is turned on slightly later than the optimum time.

In FIG. 9A is presented one embodiment of this specification wherein the snubber switch is implemented by a switching element Sy, 390, controlled by a signal Vcss, 470. A diode Ds, 410, is placed in parallel with the switch Sy, 390.

For efficient operation the control signal V_{Css}, preferably have two features. First is that the control switch Ss, 390, complies with the first embodiment of this disclosure wherein the conduction time of the switch makes the switch a “charge equalizer switch”. This defines the time interval wherein the switch Sy, 390, has to be on.

The second embodiment of this disclosure is for the switch Sy, 390, to turn on at the “critical time”. In many applications the large dV/dt voltage which occurs in between IN⁺, 420, and IN⁻, 430, delays the conduction of the diode, Ds, 410, due to the forward recovery time of the diode Ds, 410, from the snubber module, 440. For that reason, the switch Ss, 390, turns on at the “critical time”.

In FIG. 9A we depict the current through the switch Sy, 390. A current through Sy, 390, has a positive polarity if it flows in the same direction as Iss+, 396, and a negative polarity if it flows in opposite polarity of Iss+. We define the “critical time” the time when Sy, 390 is turned on, the current through Sy, 390 has a negative polarity at the −0.5% of “critical time” and has a positive polarity at the +0.5% of “critical time”.

In conclusion the control signal V_{Css}, 470 for Sy, 390, has to meet the first and second embodiment of this specification wherein the first embodiment refers to the duration of the conduction of Sy, 390, which has to be large enough that the charge injected in the snubber capacitor will be equal with the charge extracted from the snubber capacitor. That will make the switch a “charge equalizer switch”. The second embodiment is that the turn on of the switch Ss, 390 must be at the “critical time”.

The snubber presented in FIG. 9A can be implemented in many ways. It is presented here in several implementations. In FIG. 9B is depicted the snubber module 440, which has two input connections, IN⁺, 420 and IN⁻, 430, said input connections which are placed across the rectifier means device Dd, 460. In addition to it there is a control signal source, 450, which provides the control signal V_{Css}, 470 for the switching device incorporated in the Snubber Module, 440.

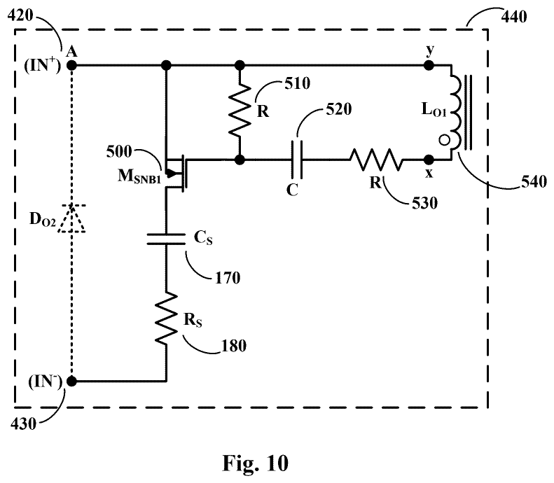

One example of Snubber Module is presented in FIG. 10. The implementation of the snubber module, 440, contains the snubber elements, Cs, 170, the snubber resistor Rs, 180 and the control switching element M_{SNB1}, 500.

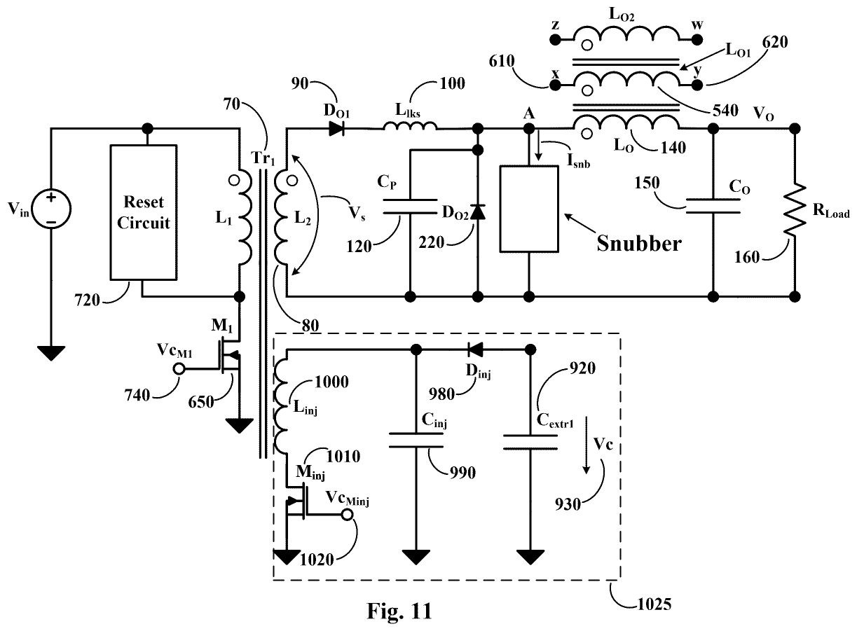

In FIG. 10 the control for the switching element M_{SNB1} is done by the winding Lo1, 540, which is coupled tightly with the output inductor Lo, 140, presented in FIG. 11. The coupled winding Lo1, 540 has two terminations, x, 610 and y, 620. The driver of the control switching element contains several components designed to create a “derivative signal in the gate of M_{SNB1}, 500, from FIG. 10, for the purpose to drive the switching device M_{SNB1}, for a given interval only, to make the switch a “charge equalizer switch”.

In FIG. 12 are depicted some of the waveforms associated with the circuit depicted in FIG. 10. Some of the waveforms are: as the voltage across the output inductor depicted in FIG. 11, the voltage in the gate of the switch M_{SNB1}, the simplified transconductance of the switch M_{SNB1}, the current through M_{SNB1}, I_{(MSNB1)}, and the voltage in the switching node A. The voltage across Lo, 140, becomes positive at the dot, at t0. At t1, the voltage in the gate of M_{SNB1} reaches the turn on threshold and M_{SNB1} turns on. The current may flow even ahead of t1, via the body diode of M_{SNB1}.

The switch M_{SNB1}, 500 shall turn on at the “critical time”. In some application wherein the leakage inductance of the transformer Tr1, 70, it is very small, the signal provided by the coupled winding Lo1 which drives M_{SNB1} may qualify for compliance with the second embodiment of this specification referring to “critical time”.

In some application wherein the leakage inductance in the transformer Tr1, 70, is higher and the signal provided by Lo1 experiences delays wherein the compliance with the “critical time” is not achieved. The signal from the Lo1, is preferably replaced by a signal provided by a magnetic element which has the primary winding driven by the signals which drive the primary switchers.

In the snubber concept depicted in FIG. 10, and FIG. 12, the presence of the switch M_{SNB1}, 500, improves significantly the efficiency of the snubber module 440 over the conventional snubber from FIG. 2. The energy stored in the snubber capacitor Cs is not fully dissipated at each cycle when Do2 starts conducting. In the low loss snubber concept depicted in FIGS. 10 and 12, the snubber capacitors retains its charge if is charge as depicted in FIG. 7, by V_{Cs}. Though this is a significant improvement over the conventional snubber, the energy injected from the leakage inductance Llk, 100, is partially dissipated by snubber resistor Rs, 180 and some of that energy is further transferred in the current through the output inductor Lo, 140.

In other snubber solutions, the energy from the leakage inductance Llk, 100 is fully transferred to a voltage source V_{B}, 850 instead of being dissipated. The diode Dc1, 800, is chosen to be a rectifier with a large reverse recovery characteristic. As a result, there is a forward charge flowing through Dc1, 800 and D1, 820, injected in VB, 850, and a reverse charge flowing through Ry, 840, D2, 830, and Cc1, 810. The rectifier Dc1, 800, has to have a reverse recovery characteristic in order to comply with preservation of charge, making switch, Dc1, 800, a “charge equalizer switch”, which was previously described.

For a larger amount of energy contained in Llk, 100, the passive snubber based on the reverse recovery charge of Dc1, 800, reaches its limitation of utilization.

Here, the passive snubber formed by Dc1, 800 is replaced by the “charge equalizer switch”. The charge equalizer switch is formed by a Mosfet switch and an intelligent control which turns on the switch at a time and for a duration to make the switch a charge equalizer switch.

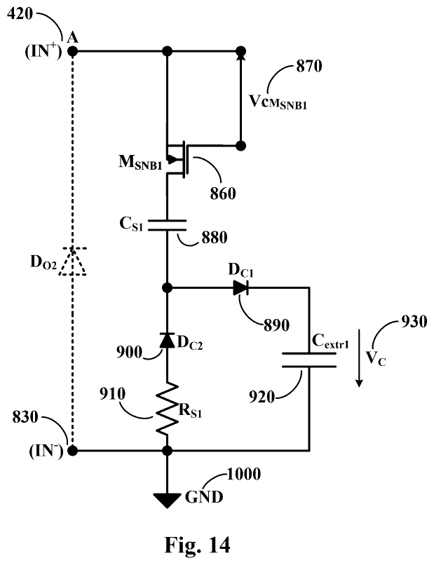

In FIG. 14 is presented the third embodiment of this specification which is the “optimized snubber”. It is formed by a controlled switch M_{SNB1}, a snubber capacitor Cs1, 880, a forward charge diode Dc1, 890, and a reverse charge diode Dc2, 900, in series with a resistor, Rs1, 910. The cathode of the forward charge diode is connected to the energy storage capacitor Cextr1 which has a charge with a voltage Vc, 930.

In the optimized snubber previously presented the control signal VCM_{SNB1} makes the switch M_{SNB1}, a charge equalizer switch, wherein the charge injected in the snubber capacitor is equal with the charge extracted from the snubber capacitor, and wherein the turn on of switch M_{SNB1} is done at the critical time.

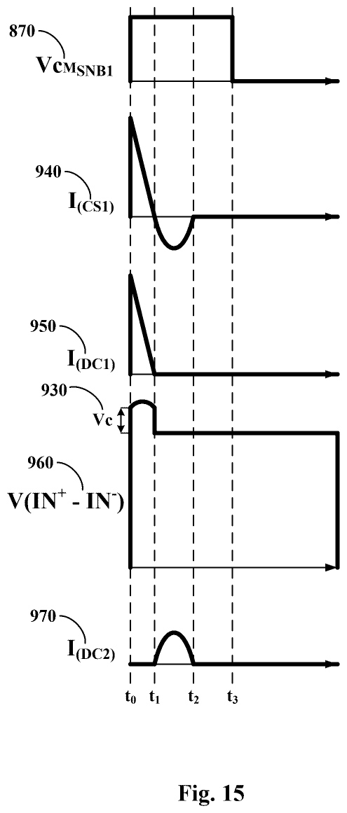

Some of the waveforms associated with the “Optimized Snubber” are presented in FIG. 15. The waveforms depicted in FIG. 15 are, the control signal of the charge equalizer switch, V_{CMSNB1}, the current through I_{(CS1)}, 940, the current through Dc1, I(DC1), the voltage in between IN⁺ to IN⁻, and the current through D_{C2}, I_{(DC2)}.

In between t0-t1 the energy from the Lₗₖ is injected into the optimized snubber circuit via M_{SNB1}, C_{S1} and D_{C1}, into Cₑₓₜᵣ₁.

In between t1 to t2 the charge injected in CS1 during t0 to t1, is extracted during t1 to t2. The limitation associated with the reverse recovery characteristics of Dc1, 800, from FIG. 13 are eliminated in this disclosure, and said “optimized snubber” can operate at any level of energy contained in Llk, 100. The optimized snubber depicted in Figure14, complies with the embodiments of this description wherein the switch, M_{SNB1}, 860, is a “charge equalizer switch”, and said switch is turn on at the “critical time”.

In the optimized snubber concept presented in FIG. 14, wherein some of its waveforms are depicted in FIG. 15, the energy from the leakage inductance Llk, 100, is totally transferred to Cextr1, which develops a voltage across it, Vc, 930. In the previous snubbing circuits, a portion of the energy from the leakage inductance is dissipated in the snubber resistor, in order to dampen the ringing in the switching node A, 110. This is totally different from the previous snubbers because the energy from the leakage inductance is stored in a energy storage capacitor, Cextr1.

The next step in in this snubber technology is to extract the energy injected in Cextr1 and use it for other functions in the power converter.

Such a function in power converter is to discharge the parasitic capacitance reflected across the main switch in order to obtain zero voltage switching for the main switch.

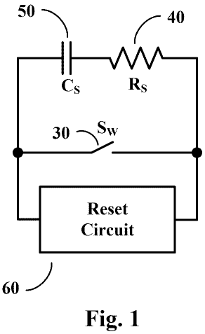

The current injection technology, presented in the U.S. Pat. No. 10,574,148 and its continuing applications, energy is extracted from Vinj, 134, from FIG. 1, of said patent, to generate a pulse of current which will flow from the current injection winding, to the primary winding in order to discharge the parasitic capacitance reflected across said main switch.

In FIG. 11 is presented such a current injection circuit formed by a current injection winding, 1000, a current injection switch Minj, 1010, a current injection driving puls, 1020, a current injection capacitor, Cinj, 990, a current injection diode Dinj, 980 and a current injection voltage source formed by a charged capacitor, Cextr1, 920, charged at a voltage level Vc, 930.

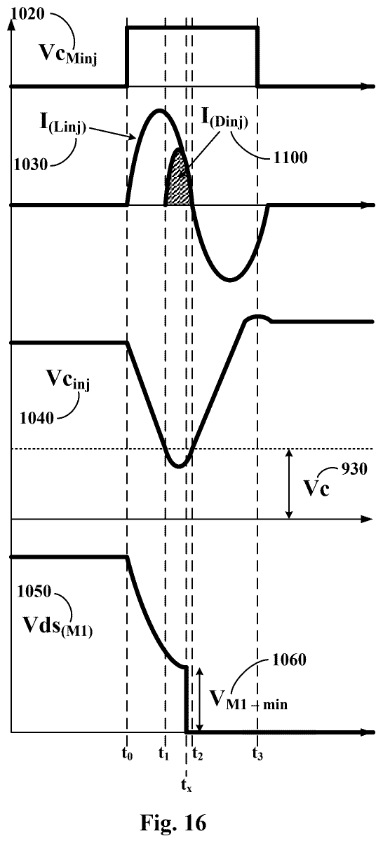

Some of the waveforms associated with the current injection circuit, 1020, are presented in FIG. 16. Some of the waveforms associated with the current injection circuit, 1025, are: the control signal for Minj, VcMinj, the current through the current injection winding, Linj, 1000, which is I(Linj), 1030, the voltage across Cinj, 990, which is VCinj, 1040, and the voltage across the primary switch M1, Vds(M1), 1050.

At t0, Minj, 1010, is turned on, and from t0 to t1 a current start flowing from Cinj, via Linj, and further reflected in the primary winding L1, starting to discharge the parasitic capacitance reflected across M1, 1010.

At t1 the voltage across Cinj, 990, decreases under the voltage amplitude of Vc, 930, and energy will be extracted from Cextr1, 920, via Dinj, 980, and energize the current injection current. The energy transfer from Cextr1, 920, is done in between t1 to t2.

In between t0 to tx the voltage across M1 is discharged to a lower level than the voltage level at t0. Ideally the voltage across M1, would be zero at tx, creating ZVS condition at turn on for M1. In some applications the voltage across M1 will decay to a lower level, such as Vi_min 1060 when M1 turns on at tx.

At t2 the current through Linj reaches zero and further in between t2 to t3 the Cinj capacitor will be charged via Linj, from the input voltage in a quasi-resonant way. In conclusion the energy for the current injection comes from two sources. The first source is from Cinj, which is charged at each cycle from the input voltage, via the leakage inductance between the primary winding and the current injection winding in a quasi-resonant way. The second source of energy is from Cextr1, 920 via the Dinj, 980.

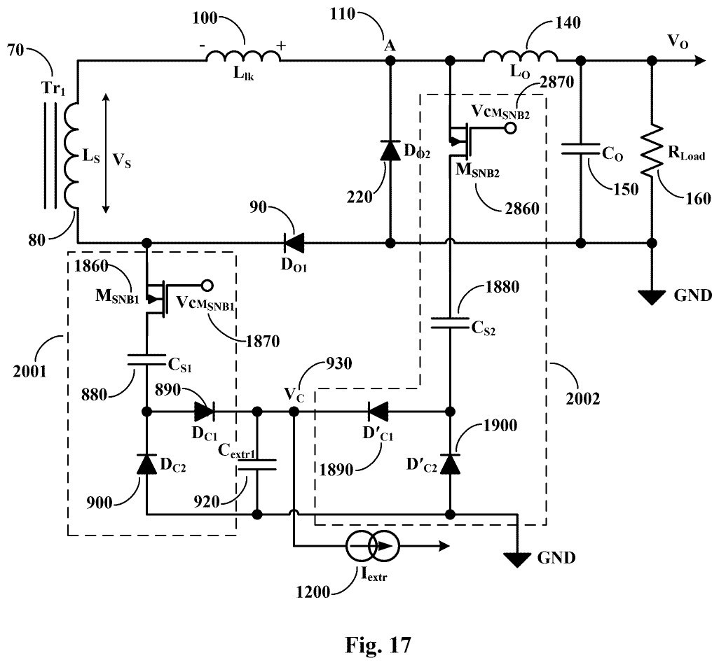

In FIG. 17 is presented the secondary of a single ended forward topology, having a secondary winding Ls, 80, and two secondary rectifiers, Do1, 90 and Do2, 220, an output inductor Lo, 140, and output capacitor Co, 150, and a load, R_{Load}, 160.

For each output rectifier there is an optimized snubber, the first optimized snubber, 2001, placed across Do1, 90 and a second optimized snubber, 2002, placed across Do2, 220.

Each optimized snubber is formed by a charge equalizer active switch, which is turned on at said “critical time”, in series with a clamp capacitor, further a forward charge diode and a reverse charge diode, wherein the energy from the leakage inductance Llk, 100, is extracted and injected in the capacitor Cₑₓₜᵣ₁ and further said energy from Cₑₓₜᵣ₁ is extracted by the current source Iextr, 1200.

There are several embodiments of this specification which present several methods of energy extraction from Cextr1, via Iextr, and used for different functions in the power converter. One of such function is to obtain zero voltage switching across the primary switching elements, by the use by current injection, which is energized by the energy provided by the optimized snubber, which extracts the energy form the switching nodes, where the optimized snubbers are connected.

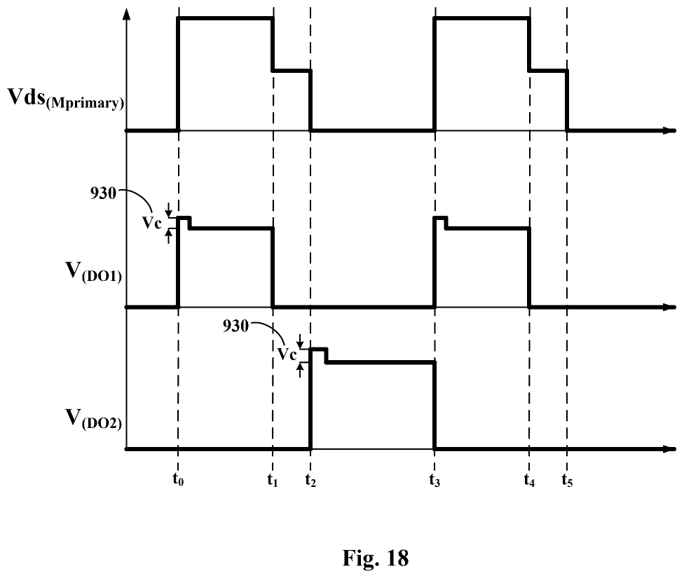

In FIG. 18 are depicted some of the waveforms associated with the circuit from FIG. 17. The waveforms from FIG. 18, are, the voltage across the primary switchers in the primary, the voltage across the forward diode, Do1, 90, and across the freewheeling rectifier, Do2, 220, in the conditions wherein an optimized snubbers is connected across said diodes.

There are several features of the optimized snubber.

One of the features of the optimized snubber which differentiate it from the rest of snubber technologies is that the energy from the leakage inductance which creates spikes and ringing in the switching nodes wherein the rectifiers are connected, is extracted and store it in a Cextrl capacitor from where the energy is further extracted by Iextr and used for different purposes aimed at increasing the performances of the power converters, such as zero voltage switching.

In FIG. 18, between t0 to t1 is the reset time of the forward converter, from t1 to t2 is the dead time and between t2 to t3 is the on time wherein energy is extracted from the input of the converter and transferred to the secondary. The optimized snubber eliminates the spikes and ringing across the rectifiers, and the voltage across the rectifier do have an overshot which represents the voltage, Vc,930, which is the voltage across Cₑₓₜᵣ₁, reflected on the voltage across the rectifiers. This is depicted in FIG. 18, on the voltage across the output rectifiers, such as V(Do1) and V(Do2),

Another solution of extracting the energy from the Cextr1, 920, capacitor besides the current injection circuit presented in FIG. 17, is to extract its energy from said capacitor Cextr1, 920, via the output inductor and transfer its energy to the output, Vo, to the output capacitor. This is another embodiment of this specification.

In a power system we may have several rectifiers which require snubbers to be placed across them in order to eliminate voltage spikes and ringing across them and ideally in the case of the use of “optimized snubber” to extract the energy form the leakage inductance and use it for different purposed in the power systems.

In FIG. 17 is presented a single ended forward converter wherein there are two rectifiers in the secondary, the forward rectifier, D01 and the freewheeling rectifier, D02, and each of said rectifiers have an optimized snubber place across them, the optimized snubber, 2002, placed across the freewheeling rectifier, and a forward snubber, 2001, placed across the forward rectifier. The energy which is extracted via the two said optimized snubbers is injected in the capacitor Cextr1, wherein the energy is further transferred into the current source Iextr, 1200.

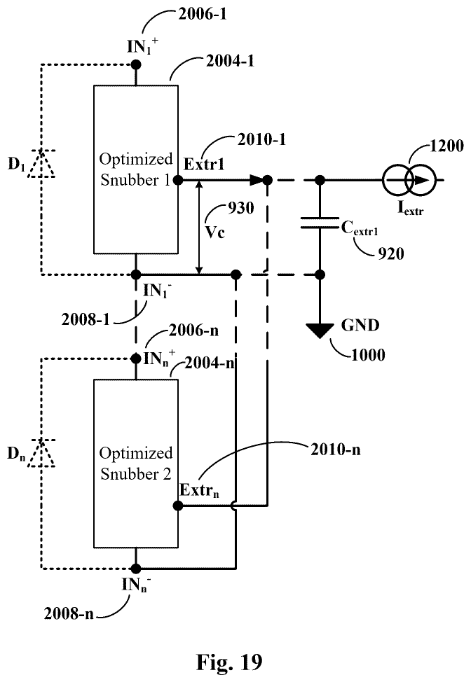

In FIG. 19 we have a generalized power converter having a “n” number of rectifiers means and across each rectifier means there is an optimized snubber. In FIG. 17 it is an example wherein there are only two optimized snubbers, 2001 and 2002.

In FIG. 19 is presented a power system having a “n” number of rectifiers and on each rectifier, there is an optimized snubber. Each optimized snubber has three terminals. The terminal of the optimized snubber is IN⁺n which is placed in the cathode of the rectifier, IN⁻n which is placed in the anode of the rectifier or synchronized rectifier, and an output Eexter₁ which is connected to the Cextr, 920, which is further discharged by the current source Iextr1, 1200. In FIG. 19, the IN⁻n are connected together as is done in FIG. 17, wherein are connected to GND, 1000. In some applications the common connection of the optimized snubbers may be at a different potential but that does not change the mode of operation.

The clamp capacitors of the optimized snubber are charged at different voltage levels, accommodating different rectifiers and extracting the energy from the leakage inductance and inject said energy it in the same capacitor Cextr1, and further discharged by the Iextr. Another embodiment of this specification is extracting the energy from Cextr1 and use it for different purposes, one of it is extracting the energy from Cextr1 and place it into the output capacitor Co, 150.

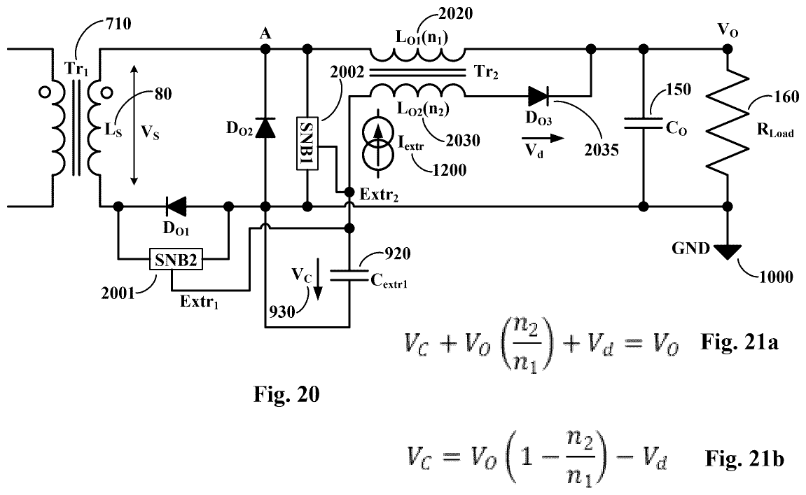

In FIG. 20 is presented another method of energy extraction from Cextr1. The method uses a secondary winding Lo2, having n2 number of turns tightly coupled with the output inductor Lo1 with a n1 number of turns. A diode Do3, is placed in series with the auxiliary winding connected with the cathode to the output Vo. Across each output rectifier, Do1and Do2 there is an optimized snubber, SNB1 and SNB2. The outputs, Extr1 and Extr2 of each optimized snubber circuit are connected together and connected to Cextr1, 920. The first termination of Lo2, is connected to the anode of Do3, 2030. The second connection of Lo2(n2) is connected to Cextr1 which stores the energy extracted from all the snubber modules, such as 2001 and 2002.

In FIG. 21a and FIG. 21b are presented the equations which presents the voltage across Cestr1, 920, as a function of output voltage Vo, the number of turns in Lo1, n1 and the number of turns in Lo2, n2. In FIG. 21b is presented the value of the voltage across the Cextr1, Vc, versus n2, n1 and Vo and Vd, which is the voltage drop on the rectifier Do3, 2035.

This method of energy extraction from Cextrl keeps the voltage across Cextr1, to a constant voltage function of the output voltage. The level of Vc, 930, can be tailored function of the number of turns in Lo1 and the number of turns in Lo2. The overshoot, Vc, 930, across the voltage across Do1 and Do2, depicted in FIG. 18, can be controlled to the desired level by the designer.

The optimized snubber presented here is a lossless snubber because the energy from the leakage inductance which leads to spikes and ringing across the rectifier means is used for some special needs in the power converter, such as obtaining zero voltage switching and improving the performances or recycled back to the input or to the output. There is no power dissipation in order to dampen the ringing across the rectifiers, and there is no ringing and spikes on the rectifiers. Across the rectifiers there is an overshot which has the amplitude Vc, 930, amplitude which can be controlled by the designer. dissipation The energy collected by the optimized snubbers herein can be injected into the same storage capacitor, from which the energy can be further extracted and used for special purposes in the power converter, such as to obtain zero voltage switching conditions in the primary or to transfer said energy back to the input voltage or to the output voltage.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

what is claimed is:

1. A DC-DC converter comprising:
a rectifying diode, an input circuit coupled to the rectifying diode, and an output circuit coupled to the rectifying diode; and
a snubber circuit connected in parallel with the rectifying diode, wherein the snubber circuit comprises a controlled switching element which is a charge equalizer active switch configured to turn on at a critical time.
